(19) United States
(12) Patent Application Publication
(10) Pub. No.: US 2009/0249011 A1
(43) Pub. Date: Oct. 1, 2009

(54) DELIVERY DATA BACKUP APPARATUS, DELIVERY DATA BACKUP METHOD AND DELIVERY DATA BACKUP PROGRAM

(75) Inventor: Shinji Ohishi, Fukuoka (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/410,082

(22) Filed: Mar. 24, 2009

(30) Foreign Application Priority Data
Mar. 27, 2008 (JP) 2008-084666

(51) Int. Cl. G06F 12/16; G06F 12/00; G06F 15/16

(52) U.S. Cl. 711/162; 709/217; 711/E12.001; 711/E12.103

(57) ABSTRACT

A delivery data backup apparatus, a delivery data backup method, and delivery data backup program are provided. The apparatus includes a delivery data receiving part receiving, from a data delivery server, delivery data transmitted from the data delivery server to a terminal device in response to a download request for the delivery data issued by the terminal device is provided. The apparatus includes a temporary storage part temporarily storing the delivery data received by the delivery data receiving part and a delivery data backup storage part storing, for backup, the received delivery data. The apparatus includes a backup process part moving the delivery data having been temporarily stored in the temporary storage part from the temporary storage part to the delivery data backup storage part in accordance with a backup instruction for the delivery data issued by the terminal device.

### CROSS-REFERENCE TO RELATED APPLICATION(S)

This application is based upon and claims priority to Japanese Patent Application No. 2008-084666, filed on Mar. 27, 2008, incorporated by reference herein.

### BACKGROUND

1. Field

The embodiments discussed herein are directed to a delivery data backup apparatus, a delivery data backup method and a delivery data backup program employed for performing a backup process for delivery data transmitted to a terminal device.

2. Description of the Related Art

Conventionally, a data delivery service in which delivery data of contents, such as static images or dynamic images, and application programs is downloaded for use through a network from a data delivery server to a terminal device has been described. Delivery service of delivery data for mobile communication terminal devices, that is, a kind of terminal devices, is increasing in use.

In such delivery service, however, downloaded data may be merely stored in a terminal device, and hence, when the data is deleted or damaged or the terminal device is changed, the user of the terminal device cannot disadvantageously utilize the delivery data unless the same delivery data is re-downloaded from the data delivery server.

Download of delivery data is one form of purchase of the delivery data, and hence, every time the delivery data is downloaded, the user of the terminal device may be charged. Therefore, when delivery data is re-downloaded, the user should bear double expense. Moreover, if the delivery data has been deleted from the data delivery server, the user can disadvantageously never again use the delivery data.

In order to overcome the aforementioned disadvantages, conventionally, a backup server for backup of delivery data having been downloaded to a terminal device is prepared so as to backup the delivery data for each user. Conventionally, even when a user has deleted downloaded delivery data by mistake, the delivery data can be recovered in the terminal device by acquiring it from the backup server.

Conventionally, a management server for collecting and managing download information used in downloading delivery data from a data delivery server to a terminal device may be prepared. When the delivery data is to be re-downloaded to the terminal device, the management server stands proxy for the terminal device so as to re-download the delivery data from the data delivery server by using the download information.

These conventional techniques are described in, for example, Japanese Laid-Open Patent Publication No. 2006-203512 and 2004-21424.

### SUMMARY

It is an aspect of the embodiments discussed herein to provide a delivery data backup apparatus that includes a delivery data receiving part receiving, from a data delivery server, delivery data transmitted from the data delivery server to a terminal device in response to a download request for the delivery data issued by the terminal device, a temporary storage part temporarily storing the delivery data received by the delivery data receiving part; a delivery data backup storage part storing, for backup, the received delivery data, and a backup process part moving the delivery data having been temporarily stored in the temporary storage part from the temporary storage part to the delivery data backup storage part in accordance with a backup instruction for the delivery data issued by the terminal device.

It is another aspect of the embodiments discussed herein to provide a delivery data backup method including receiving, from a data delivery server, delivery data transmitted from the data delivery server to a terminal device in response to a download request for the delivery data issued by the terminal device, temporarily storing the received delivery data in a temporary storage device, storing the delivery data for backup in an ultimate storage device, and moving the delivery data having been temporarily stored in the temporary storage device from the temporary storage device to a delivery data backup storage device in accordance with a backup instruction for the delivery data issued by the terminal device.

It is another aspect of the embodiments discussed herein to provide a computer-readable storage medium storing a delivery data backup program, the delivery data backup program that causes the computer to execute receiving, from a data delivery server, delivery data transmitted from the data delivery server to a terminal device in response to a download request for the delivery data issued by the terminal device, temporarily storing, in a temporary storage device, the delivery data received by the receiving, storing the delivery data for backup in an ultimate storage device, and moving the delivery data having been temporarily stored in the temporary storage device by the temporarily storing from the temporary storage device to a delivery data backup storage device in accordance with a backup instruction for the delivery data issued by the terminal device.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 illustrates an exemplary content delivery system.

FIG. 2 illustrates an exemplary content delivery system.

FIG. 3 illustrates an exemplary control messages sent/received between a backup server and a mobile terminal.

FIG. 4 illustrates an exemplary content backup process performed in a content delivery system.

FIG. 5 illustrates an exemplary downstream content analysis process performed in a backup server.

FIG. 6 illustrates an upstream content analysis process performed in a backup server.

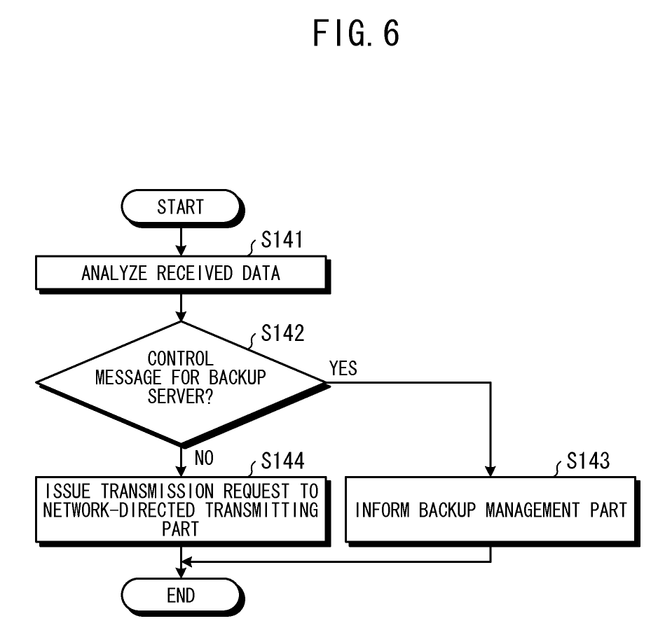

FIG. 7 illustrates an exemplary information signal receiving process performed in a backup server.

FIG. 8 illustrates exemplary backup process performed in a backup server.

FIG. 9 illustrates an exemplary user authentication process performed in a backup server.

FIG. 10 illustrates an exemplary control signal receiving process performed in a mobile terminal.

FIG. 11 illustrates an exemplary user operation accepting process performed in a mobile terminal.

FIG. 12 illustrates a control signal receiving process performed in a mobile terminal.

FIG. 13 illustrates a content delivery system in a second embodiment.

FIG. 14 illustrates an exemplary content delivery system.

FIG. 15 illustrates an exemplary content backup process performed in a content delivery system.

FIG. 16 illustrates an exemplary upload process performed in a content server.

FIG. 17 illustrates an exemplary content delivery process performed in a content server.

### DETAILED DESCRIPTION OF EMBODIMENTS

Exemplary embodiments of a delivery data backup unit, a delivery data backup method and a delivery data backup program are described. A terminal device may be a mobile terminal, such as a cellular phone, for receiving delivery data through radio communications in the following embodiments.

The terminal device may communicate with a delivery data backup unit and a data delivery unit connected to a network through a base station and a gateway server (gateway unit) connected to a line switching network.

The data delivery unit may be a content server delivering contents such as static images, dynamic images and application program data and may be connected to the present delivery data backup unit through the network.

The terminal device is, however, not limited to a mobile terminal performing radio communication but may be a non-mobile terminal performing wire communication. Also, the delivery data backup unit and the data delivery unit need not be separate apparatuses but may be an integrated apparatus.

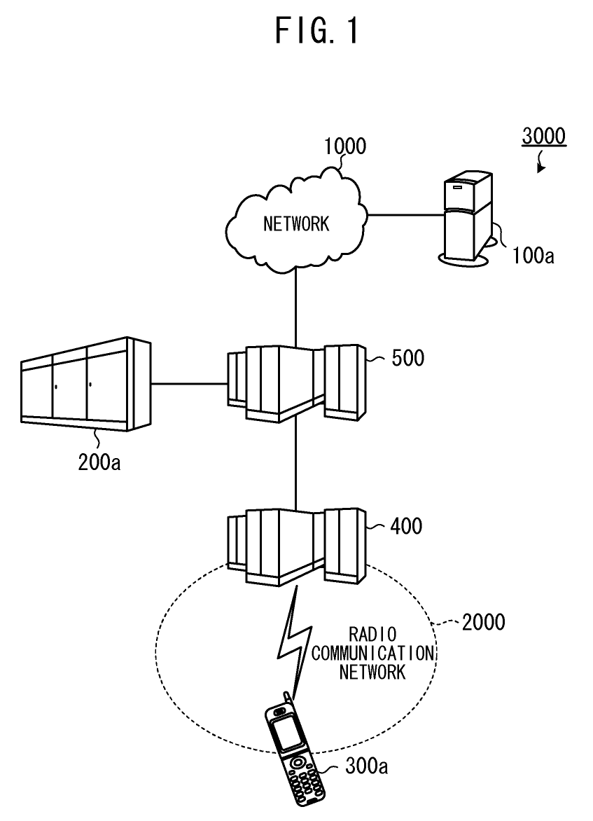

FIG. 1 illustrates an exemplary content delivery system. As illustrated in FIG. 1, in the content delivery system 3000, a content server 100a and a gateway server 500 may be connected to a network 1000.

Furthermore, a backup server 200a of Embodiment 1 may be disposed in a DMZ (DeMilitarized Zone) of the gateway server 500. A base station server 400 of a mobile communication system performs radio communication through packet transmission with a mobile terminal 300a present in a radio communication network 2000.

The base station server 400 passes a delivery request packet for a content received from the mobile terminal 300a to the gateway server 500. Also, the base station server 400 may transmit, from the gateway server 500 to the mobile terminal 300a, content data corresponding to the delivery request packet received from the mobile terminal 300a.

The gateway server 500 may transmit, through the base station server 400 to the backup server 200a, a delivery request packet for a content issued by the mobile terminal 300a to the content server 100a.

When the delivery request packet for a content issued by the mobile terminal 300a to the content server 100a is received, the backup server 200a may request the content server 100a to transmit the corresponding content to itself.

When the transmission request for the content is received from the backup server 200a, the content server 100a may transmit the corresponding content to the backup server 200a. The backup server 200a temporarily may store the received content and may transmit the content to the mobile terminal 300a, that is, an originator of the content delivery request.

The mobile terminal 300a temporarily may store the received content. When the mobile terminal 300a ultimately stores the temporarily stored content in a nonvolatile memory or the like, the mobile terminal 300a instructs the backup server 200a to ultimately store the content having been temporarily stored in the backup server 200a in a nonvolatile memory or the like.

In accordance with the instruction from the mobile terminal 300a, the backup server 200a ultimately stores the temporarily stored content in a nonvolatile memory or the like. This process may correspond to a content backup process attendant on the download of a content.

Since the backup server 200a relays a content download request from the mobile terminal 300a and automatically performs backup of the content in relaying, the content can be definitely backed up even when a user of the mobile terminal 300a is unaware of the backup.

Furthermore, even when the content is deleted by mistake or damaged in data, or even when the mobile terminal 300a itself is changed in its model, the user of the mobile terminal 300a can acquire the same content not from the content server 100a but from the backup server 200a, and without a re-download of the same content from the content server 100a.

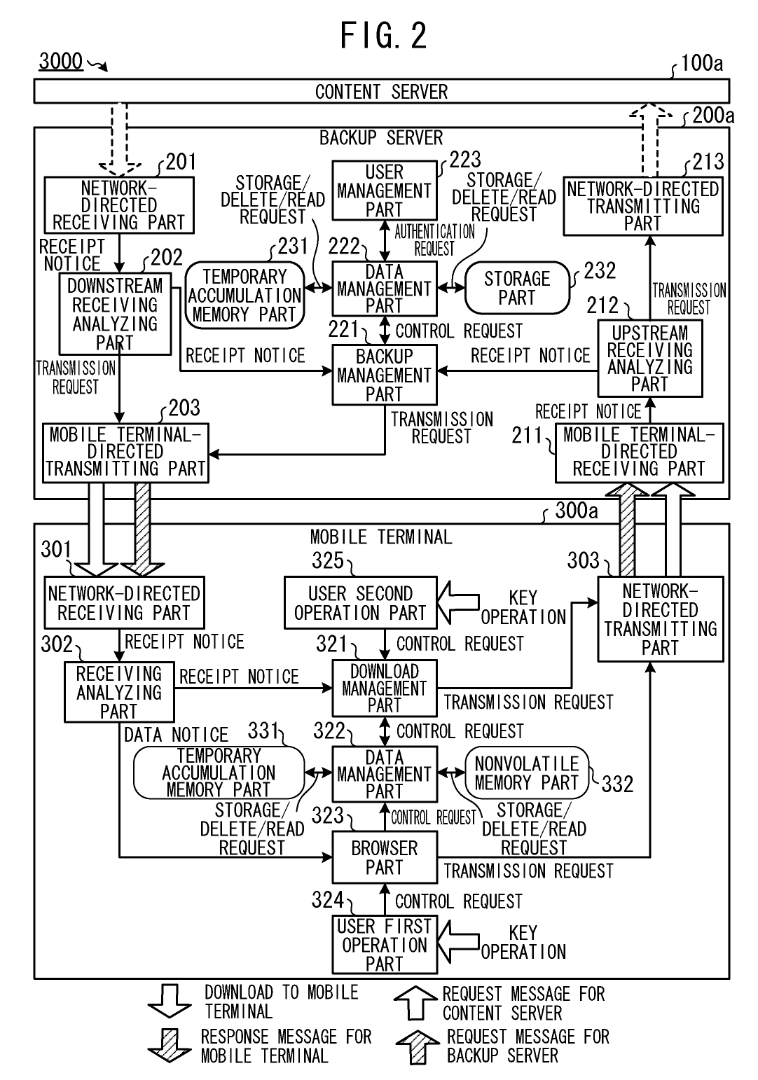

FIG. 2 illustrates a content delivery system. As illustrated in FIG. 2, a first exemplary embodiment includes a backup server 200a and the mobile terminal 300a.

It is noted that “download data” or “content data” to be downloaded from the content server 100a to the mobile terminal 300a is designated simply as a “content” in the following description.

Referring to FIG. 2, the backup server 200a includes transferring content data received from the content server 100a to the mobile terminal 300a, a network-directed receiving part 201, a downstream receiving analyzing part 202 and a mobile terminal-directed transmitting part 203.

The backup server 200a includes, transferring a content delivery request received from the mobile terminal 300a to the content server 100a, a mobile terminal-directed receiving part 211, an upstream receiving analyzing part 212 and a network-directed transmitting part 213.

The backup server 200a includes, related to the content backup process, a backup management part 221, a data management part 222, a user management part 223, a temporary accumulation memory part 231 for temporarily storing a content and a storage part 232 corresponding to a nonvolatile memory for ultimately storing a content.

The mobile terminal 300a includes a network-directed transmitting part 303 transmitting a content delivery request to the content server 100a through the backup server 200a.

The mobile terminal 300a includes, receiving a content from the content server 100a through the backup server 200a, a network-directed receiving part 301 and a receiving analyzing part 302.

The mobile terminal 300a includes, performing a process related to a downloaded content, a download management part 321, a data management part 322, a browser part 323, a user first operation part 324, a user second operation part 325, a temporary accumulation memory part 331 for temporarily storing a content and a nonvolatile memory part 332 for ultimately storing a content.

A content delivery (download) request process is described. In downloading a content from the content server 100a to the mobile terminal 300a, a user of the mobile terminal 300a enters a command to execute the download into the browser part 323 by operating the user first operation part 324.

When the command to execute the download is entered by the user of the mobile terminal 300a, the browser part 323 generates a content delivery request message for the content server 100a. A request is issued, to the network-directed transmitting part 303, for transmitting the content delivery request message.

The network-directed transmitting part 303 may transmit the content delivery request message to the content server 100a in response to the content delivery request issued by the browser part 323.

The content delivery request message from the mobile terminal 300a is transmitted to the content server 100a through the backup server 200a. In the backup server 200a, the content delivery request message from the mobile terminal 300a is received by the mobile terminal-directed receiving part 211 to be sent to the upstream receiving analyzing part 212.

The upstream receiving analyzing part 212 analyzes the received message, and when it is determined to be a content delivery request message for the content server 100a, the upstream receiving analyzing part 212 may request the network-directed transmitting part 213 to transmit the content delivery request to the content server 100a.

The network-directed transmitting part 213 may transmit the content delivery request message from the mobile terminal 300a to the content server 100a. The content server 100a may transmit the corresponding content to the mobile terminal 300a in response to the content delivery request from the mobile terminal 300a received through the backup server 200a.

The content sent from the content server 100a is transmitted to the mobile terminal 300a through the backup server 200a. In the backup server 200a, the content sent from the content server 100a is received by the network-directed receiving part 201 and the received content is sent to the downstream receiving analyzing part 202.

The downstream receiving analyzing part 202 analyzes the received content, and when it is determined to be a content for the mobile terminal 300a corresponding to the originator of the delivery request for the content, the downstream receiving analyzing part 202 informs the backup management part 221 of it and issues a request, to the mobile terminal-directed transmitting part 203, for transmitting the content. The mobile terminal-directed transmitting part 203 may transmit the content to the mobile terminal 300a in response to the transmission request issued by the downstream receiving analyzing part 202.

The backup management part 221 of the backup server 200a may request the data management part 222 to accumulatively store (temporarily store) the content supplied from the content server 100a together with a user identifier of the mobile terminal 300a in the temporary accumulation memory part 231.

The data management part 222 issues an authentication request based on the user identifier of the mobile terminal 300a to the user management part 223. The process of user authentication will be described in detail later. When the user has been successfully authenticated, the data management part 222 accumulatively may store the content for the mobile terminal 300a in the temporary accumulation memory part 231.

In the mobile terminal 300a, data supplied from the content server 100a and the backup server 200a is received by the network-directed receiving part 301. The received data is sent to the receiving analyzing part 302.

The receiving analyzing part 302 analyzes the received data. When the received data is determined to be a content supplied from the content server 100a, it is informed the browser part 323. When the received data is a content, the browser part 323 informs the user of the mobile terminal 300a of the process progress state while requesting the data management part 322 to accumulatively store the data in the temporary accumulation memory part 331.

When the content is completely received, the user inputs, through the operation of the user second operation part 325, an ultimate storage request for ultimately storing the content in the nonvolatile memory part 332 or a discard request for discarding the content from the temporary accumulation memory part 331 into the download management part 321. It is determined whether an ultimate storage request or a discard request is made depending upon the operation of the user second operation part 325 by the user.

When content is to be ultimately stored, the user issues, to the download management part 321, an ultimate storage request with a file name specified through the operation of the user second operation part 325. The download management part 321 issues a request, to the data management part 322, for ultimately storing, in the nonvolatile memory part 332 with the specified file name, the content having been accumulatively stored in the temporary accumulation memory part 331.

Then, the data management part 322 reads the content from the temporary accumulation memory part 331 and ultimately may store it in the nonvolatile memory part 332 with the specified file name, and thereafter, deletes the content from the temporary accumulation memory part 331. It is noted that the data management part 322 informs the download management part 321 that the ultimate storage in the nonvolatile memory part 332 has been completed.

The download management part 321, which has been informed by the data management part 322 that the ultimate storage of content in the nonvolatile memory part 332 has been completed, generates an “ultimate storage request message” for the backup server 200a. The download management part 321 issues a request, to the network-directed transmitting part 303, for transmitting the “ultimate storage request message” to the backup server 200a.

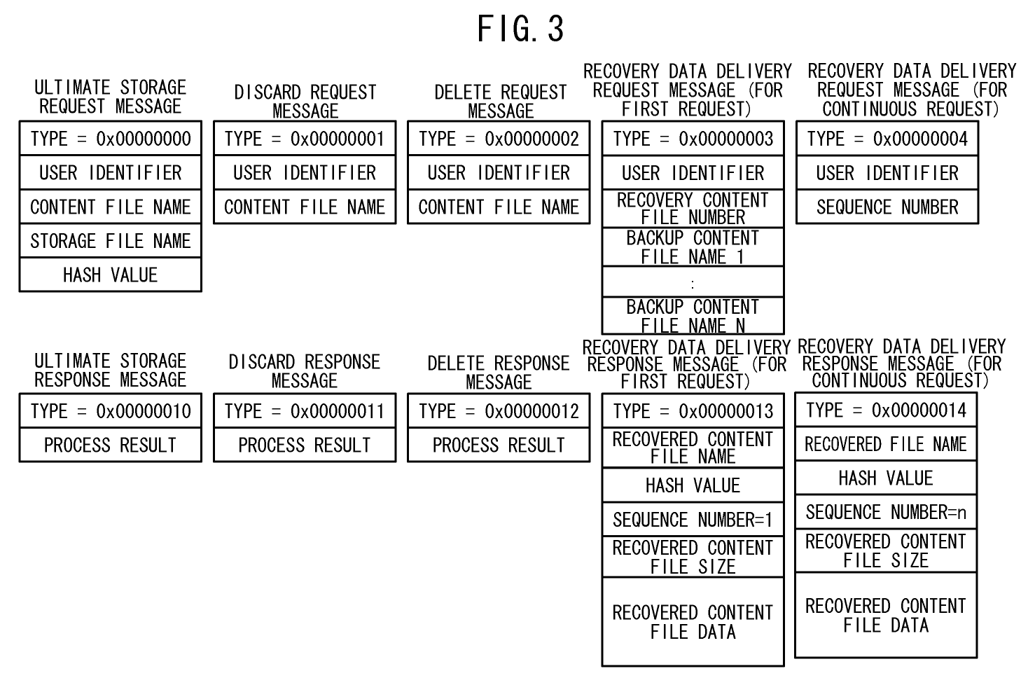

It is noted that the “ultimate storage request message” includes, as illustrated in FIG. 3, “type=0x00000000” corresponding to an “ultimate storage request message”. Also, the “ultimate storage request message” includes, as data management information, a “user identifier” of the mobile terminal 300a, that is, the originator of the “ultimate storage request message”; a “content file name” of the content to be requested for ultimate storage; a “storage file name” used for storing the content; and a “hash value” obtained based on file data of the content and used for license management of the content data.

Since the “hash value” is thus included in the “ultimate storage request message”, the content can be recovered with the “hash value” in recovery, and hence, even a recovered content can be normally reproduced in the mobile terminal 300a.

The network-directed transmitting part 303 may transmit the “ultimate storage request message” to the backup server 200a in response to the transmission request issued by the download management part 321.

The backup server 200a receives the “ultimate storage request message” from the mobile terminal 300a by the mobile terminal-directed receiving part 211, and informs the upstream receiving analyzing part 212 of the receipt. The upstream receiving analyzing part 212 analyzes the received message, and when it is determined to be an “ultimate storage request message” for the backup server 200a, the upstream receiving analyzing part 212 informs the backup management part 221 of the “ultimate storage request message”.

The backup management part 221 analyzes the message informed by the upstream receiving analyzing part 212, and when it is determined to be an “ultimate storage request message” from the mobile terminal 300a, the backup management part 221 may request the data management part 222 to ultimately store the content with the user identifier of the mobile terminal 300a and the file name of the content to be stored specified.

Then, the data management part 222 issues a user authentication request for the user to the user management part 223 by using the user identifier informed by the backup management part 221. The user authentication process will be described in detail later. When the user has been successfully authenticated by the user management part 223, the data management part 222 reads the content from the temporary accumulation memory part 231, and ultimately may store it in the storage part 232 with the specified file name. Finally, the data management part 222 deletes the content from the temporary accumulation memory part 231.

The data management part 222 informs the backup management part 221 that the ultimate storage in the storage part 232 has been completed. The backup management part 221 having been informed by the data management part 222 that the ultimate storage has been completed generates an “ultimate storage response message” for the mobile terminal 300a.

The “ultimate storage response message” includes, as illustrated in FIG. 3, “type=0x00000010” corresponding to an “ultimate storage response message”, and a “process result” of the ultimate storage process performed in the backup server 200a in response to the “ultimate storage request message”.

Then, the mobile terminal-directed transmitting part 203 is requested to transmit the ultimate storage response message to the mobile terminal 300a. The mobile terminal-directed transmitting part 203 may transmit the ultimate storage response message to the mobile terminal 300a in response to the request for transmitting the ultimate storage response message issued by the backup management part 221.

Now, respective functions related to discard of a content accumulatively stored in the backup server 200a and the mobile terminal 300a will be described. In the case where a downloaded content is not ultimately stored, the download management part 321 is requested to discard the content in accordance with an operation accepted through the user second operation part 325.

The download management part 321 may request the data management part 322 to discard data accumulatively stored in the temporary accumulation memory part 331. In response to this request, the data management part 322 deletes the corresponding content from the temporary accumulation memory part 331.

The data management part 322 informs the download management part 321 that the delete of the content has been completed in the temporary accumulation memory part 331. The download management part 321 having been informed by the data management part 322 that the delete of the content has been completed generates a “discard request message” for the backup server 200a.

The “discard request message” includes, as illustrated in FIG. 3, “type=0x00000001” corresponding to a “discard request message”, and further includes, as data management information, a “user identifier” of the mobile terminal 300a, that is, the originator of the “discard request message”, and a “content file name” of the content to be requested for discard.

The download management part 321 issues a request, to the network-directed transmitting part 303, for transmitting the “discard request message” to the backup server 200a.

At this point, the “discard request message” includes not only the “user identifier” of the mobile terminal 300a but also a hash value as the data management information. The network-directed transmitting part 303 may transmit, in response to the transmission request issued by the download management part 321, the discard request message to the backup server 200a.

The backup server 200a receives the discard request message from the mobile terminal 300a by the mobile terminal-directed receiving part 211, and sends it to the upstream receiving analyzing part 212. The upstream receiving analyzing part 212 analyzes the received message, and when it is determined to be a discard request message for the backup server 200a, the backup management part 221 is informed of it.

The backup management part 221 analyzes the message sent from the upstream receiving analyzing part 212, and when it is determined to be a discard request message from the mobile terminal 300a, the backup management part 221 issues a request, to the data management part 222, for discarding the content with the user identifier of the mobile terminal 300a and the file name of the content specified.

The data management part 222 may request the user management part 223 to perform authentication of the user, that is, the originator of the discard request by using the user identifier informed by the backup management part 221, and when the user has been successfully authenticated, the corresponding content is deleted from the temporary accumulation memory part 231. The user authentication process will be described in detail later.

The data management part 222 informs the backup management part 221 that the discard of the content has been completed by using a “discard response message”. The backup management part 221 having been informed by the data management part 222 that the discard of the content has been completed generates a “discard response message” for the mobile terminal 300a, and issues a request, to the mobile terminal-directed transmitting part 203, for transmitting the message. The mobile terminal-directed transmitting part 203 may transmit the discard response message to the mobile terminal 300a in response to the transmission request issued by the backup management part 221.

The “discard response message” includes, as illustrated in FIG. 3, “type=0x00000011” corresponding to a “discard response message”, and a “process result” of the discard process performed in the backup server 200a in response to the discard request message.

Now, respective functions related to delete of a content ultimately stored in the backup server 200a and the mobile terminal 300a will be described. A delete request with a content file name specified is issued to the download management part 321 through an operation accepted in the user second operation part 325. The delete request is issued by the mobile terminal 300a to the backup server 200a.

The download management part 321 may request the data management part 322 to delete a content ultimately stored in the nonvolatile memory part 332. Then, the data management part 322 deletes the corresponding content from the nonvolatile memory part 332.

The data management part 322 informs the download management part 321 that the delete of the content from the nonvolatile memory part 332 has been completed. Then, the download management part 321 having been informed by the data management part 322 that the delete of the content has been completed generates a “delete request message” for the backup server 200a for deleting the content ultimately stored in the storage part 232, and may request the network-directed transmitting part 303 to transmit the “delete request message”.

The “delete request message” includes, as illustrated in FIG. 3, “type=0x00000002” corresponding to a “delete request message”, and further includes, as the data management information, a “user identifier” of the mobile terminal 300a, that is, the originator of the “delete request message” and a “content file name” of the content to be requested for delete.

The network-directed transmitting part 303 may transmit the delete request message for the content to the backup server 200a in response to the transmission request issued by the download management part 321.

The backup server 200a receives the delete request message from the mobile terminal 300a by the mobile terminal-directed receiving part 211 and informs the upstream receiving analyzing part 212 of it.

The upstream receiving analyzing part 212 analyzes the received message, and when it is determined to be a delete request message for the backup server 200a, the upstream receiving analyzing part 212 informs the backup management part 221 of it.

The backup management part 221 analyzes the message informed by the upstream receiving analyzing part 212, and when it is determined to be a delete request message from the mobile terminal 300a, the backup management part 221 may request the data management part 222 to delete the content with the user identifier of the mobile terminal 300a and the content file name specified.

The data management part 222 issues an authentication request to the user management part 223 by using the user identifier informed by the backup management part 221. The user authentication process will be described in detail later. When the user has been successfully authenticated, the data management part 222 deletes the content from the storage part 232. The data management part 222 informs the backup management part 221 that the delete of the content has been completed.

The backup management part 221 having been informed by the data management part 222 that the delete of the content has been completed generates a “delete response message” for the mobile terminal 300a, and issues a request, to the mobile terminal-directed transmitting part 203, for transmitting the “delete response message”. The mobile terminal-directed transmitting part 203 may transmit the delete response message to the mobile terminal 300a in response to the transmission request issued by the backup management part 221.

The “delete response message” includes, as illustrated in FIG. 3, “type=0x00000012” corresponding to a “delete response message”, and a “process result” of the delete process performed in the backup server 200a in response to the delete request message.

Now, respective functions related to a recovery process for transmitting a content ultimately stored in the backup server 200a to the mobile terminal 300a for recovery will be described. A recovery request with a content file name specified is issued to the download management part 321 through a recovery operation accepted in the user second operation part 325. This recovery request is issued by the mobile terminal 300a to the backup server 200a.

The download management part 321 generates a “recovery data delivery request message” for a content ultimately stored in the storage part 232 of the backup server 200a, and may request the network-directed transmitting part 303 to transmit the “recovery data delivery request message” to the backup server 200a.

In issuing the recovery data delivery request, the mobile terminal 300a first may transmit a “recovery data delivery request message (for first request)” for requesting the recovery to the backup server 200a.

In response to the “recovery data delivery request message (for first request)”, the backup server 200a may transmit, to the mobile terminal 300a, “recovery content file data” corresponding to a “backup content file name” described in the “recovery data delivery request message (for first request)”.

In general, however, there are a plurality of contents requested for recovery and the amount of data is large. When the amount of recovery data is large, the mobile terminal 300a sometimes may not be able to receive the whole recovery data transmitted from the backup server 200a in response to one “recovery data delivery request message (for first request)”.

Therefore, when the whole recovery data cannot be completely received, continuous transmission for the remaining portion of the recovery data is requested. The continuous transmission request for the recovery data is made by transmitting a “recovery data delivery request message (for continuous request)”.

The “recovery data delivery request message (for first request)” includes, as illustrated in FIG. 3, “type=0x00000003” corresponding to a “recovery data delivery request message (for first request)”. Also, the “recovery data delivery request message (for first request)” includes, as the data management information, a “user identifier” of the mobile terminal 300a, that is, the originator of the “recovery data delivery request message (for first request)”; a “recovery content file number” corresponding to the number of files of the content to be requested for recovery data delivery; and a “backup content file name” corresponding to the file name of the content requested for recovery data delivery.

Then, the network-directed transmitting part 303 may transmit the “recovery data delivery request message (for first request)” to the backup server 200a in response to the transmission request issued by the download management part 321.

The backup server 200a receives the “recovery data delivery request message (for first request)” from the mobile terminal 300a by the mobile terminal-directed receiving part 211 and informs the upstream receiving analyzing part 212 of the receipt. The upstream receiving analyzing part 212 analyzes the received message, and when it is determined to be a “recovery data delivery request message (for first request)” for the backup server 200a, the backup management part 221 is informed of the “recovery data delivery request message (for first request)”.

In the backup management part 221, the message informed by the upstream receiving analyzing part 212 is analyzed, and when it is determined to be a “recovery data delivery request message (for first request)” from the mobile terminal 300a, the data management part 222 is requested to read the corresponding content with the user identifier of the mobile terminal 300a and the file name of the content to be delivered as recovery data described as a first item in the “recovery data delivery request message (for first request)” specified.

The data management part 222 issues a request, to the user management part 223, for performing authentication of the user by using the user identifier informed by the backup management part 221. The user authentication process will be described in detail later. When the user has been successfully authenticated by the user management part 223, the data management part 222 reads the corresponding content from the storage part 232, and may request the backup management part 221 to transmit the content to the mobile terminal 300a, that is, the originator of the request for the recovery data delivery.

The backup management part 221, which has received data of the content from the data management part 222 for transmitting the data to the mobile terminal 300a, that is, the originator of the request for the recovery data delivery, generates a “recovery data delivery response message” for the mobile terminal 300a.

The “recovery data delivery response message (for first request)” includes, as illustrated in FIG. 3, “type=0x00000013” corresponding to a “recovery data delivery response message (for first request)”, and further includes a “recovered content file name” corresponding to the file name of the content to be recovered; a “hash value” of the recovered content specified by the “recovered content file name”; a “sequence number=1” corresponding to a response to the first request; a “recovered content file size” corresponding to the file size of the “recovered content file” with the “recovered content file name”; and “recovered content file data” of the “recovered content file”.

The processes related to the recovery data delivery of a content to be recovered described in a “recovery data delivery request message (for first request)” have been described so far. When the whole recovery data cannot be received in response to the “recovery data delivery request message (for first request)”, the backup server 200a is requested by the mobile terminal 300a of re-transmission of the recovery data in accordance with a “recovery data delivery request message (for continuous request)”. In response to this request, recovery data of the content to be delivered is transmitted from the backup server 200a to the mobile terminal 300a.

The “recovery data delivery request message (for continuous request)” includes, as illustrated in FIG. 3, “type=0x00000004” corresponding to a “recovery data delivery request message (for continuous request)”, and further includes a “user identifier” corresponding to identification information for identifying a user of the mobile terminal 300a and a “sequence number” corresponding to the number of may request made for re-transmission. Every time a “recovery data delivery request message (for continuous request)” is transmitted, the mobile terminal 300a adds “1” to the “sequence number”. Thus, a recovery data delivery request and response may be repeated until the “sequence number” exceeds a predetermined limit value.

The “recovery data delivery response message (for continuous request)” transmitted from the backup server 200a to the mobile terminal 300a in response to a request issued by the mobile terminal 300a includes, as illustrated in FIG. 3, “type=0x00000014” corresponding to a “recovery data delivery response message (for continuous request)”, and further includes a “recovered content file name” corresponding to the file name of a content to be recovered; a “hash value” of the recovered content specified by the “recovered content file name”; a “sequence number=n” corresponding to a response to the nth (wherein n≧2) request; a “recovered content file size” corresponding to the file size of the “recovered content file” with the “recovered content file name”; and “recovered content file data” of the “recovered content file”.

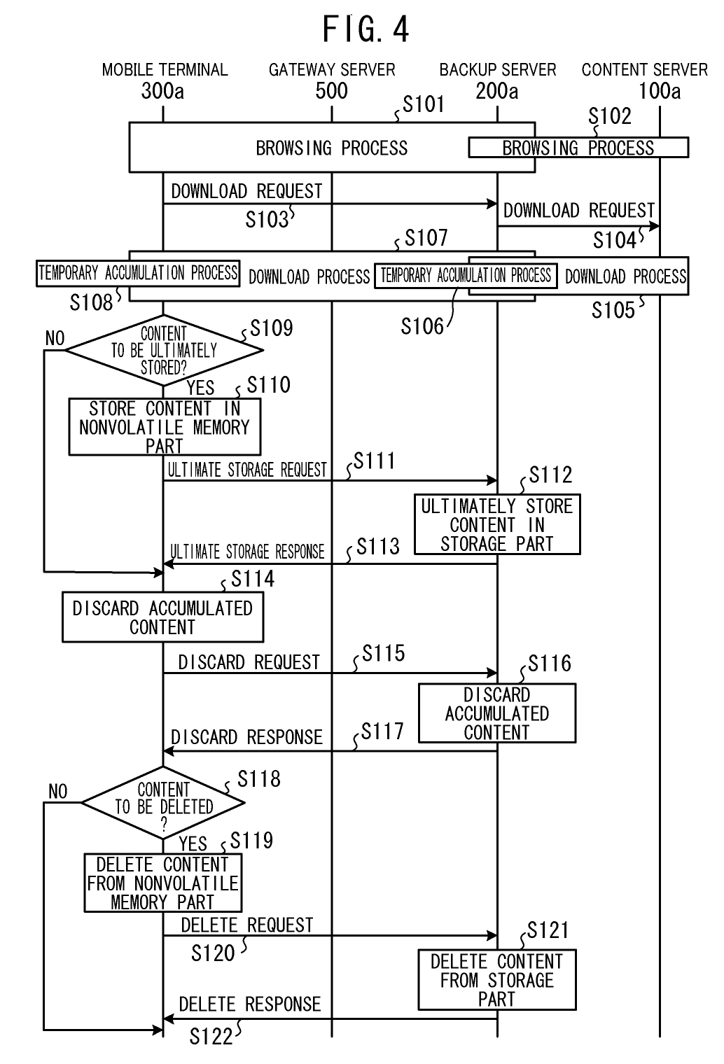

FIG. 4 illustrates a content backup process performed in the content delivery system.

The mobile terminal 300a issues a request for a browsing process for a desired content to the backup server 200a (operation S101).

The backup server 200a makes the content server 100a perform the browsing process for the desired content in response to the request for the browsing process issued by the mobile terminal 300a (operation S102).

The mobile terminal 300a issues a request for download with the content specified to the backup server 200a (operation S103). In response to this request, the backup server 200a issues a request, to the content server 100a, for downloading the content (operation S104).

In response to the download request issued in operation S104, the content server 100a performs a download process for transmitting the content to the backup server 200a (operation S105).

Then, the backup server 200a performs a temporary accumulation process for temporarily accumulating the content downloaded from the content server 100a in the temporary accumulation memory part 231 (operation S106).

The backup server 200a performs a download process for transmitting the content downloaded from the content server 100a to the mobile terminal 300a (operation S107). The mobile terminal 300a performs a temporary accumulation process for temporarily accumulating the content downloaded from the backup server 200a in the temporary accumulation memory part 331 (operation S108).

The mobile terminal 300a determines, in accordance with an operation performed by a user, whether or not the content temporarily accumulated in operation S108 is to be ultimately stored in the nonvolatile memory part 332 (operation S109). When it is determined that the content is to be ultimately stored in the nonvolatile memory part 332 (Yes in operation S109), the process proceeds to operation S110, and when not, the process proceeds to operation S114.

In operation S110, the mobile terminal 300a ultimately may store the content in the nonvolatile memory part 332. Then, the mobile terminal 300a may transmit an ultimate storage request message to the backup server 200a for ultimately storing the content in the storage part 232 (operation S111).

The backup server 200a having received the ultimate storage request message from the mobile terminal 300a ultimately may store the content in the storage part 232 (operation S112). Then, the backup server 200a may transmit an ultimate storage response message to the mobile terminal 300a (operation S113).

The mobile terminal 300a discards the content temporarily accumulated in operation S108 (operation S114). Then, the mobile terminal 300a may transmit a discard request message to the backup server 200a for discarding the content from the temporary accumulation memory part 231 (operation S115).

The backup server 200a having received the discard request message from the mobile terminal 300a discards the content from the temporary accumulation memory part 231 (operation S116). Then, the backup server 200a may transmit a discard response message to the mobile terminal 300a (operation S117).

The mobile terminal 300a determines, in accordance with an operation performed by the user, whether or not the content ultimately stored in operation S110 is to be deleted from the nonvolatile memory part 332 (operation S118). When it is determined that the content is to be deleted from the nonvolatile memory part 332 (Yes in operation S118), the process proceeds to operation S119, and when not (No in operation S118), the content backup process is completed.

In operation S119, the mobile terminal 300a deletes the content from the nonvolatile memory part 332. Then, the mobile terminal 300a may transmit a delete request message to the backup server 200a for deleting the content from the storage part 232 (operation S120).

The backup server 200a having received the delete request message from the mobile terminal 300a deletes the content from the storage part 232 (operation S121). Then, the backup server 200a may transmit a delete response message to the mobile terminal 300a (operation S122).

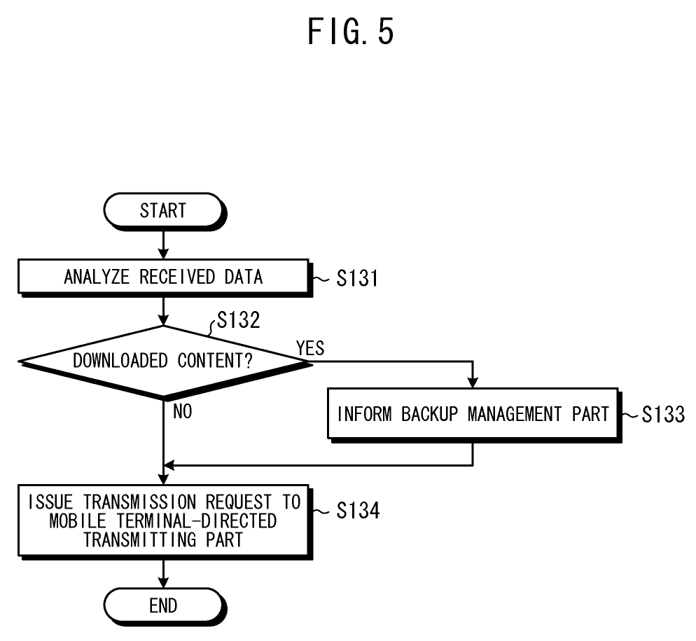

FIG. 5 illustrates a flow of the downstream content analysis process performed in a backup server.

The downstream receiving analyzing part 202 of the backup server 200a analyzes data received from the content server 100a (operation S131). Then, the downstream receiving analyzing part 202 determines whether or not the received data is downloaded content data (operation S132).

When it is determined that the received data is downloaded content data (Yes in operation S132), the process proceeds to operation S133, and when not (No in operation 4 S132), the process proceeds to operation S134.

In operation S133, the downstream receiving analyzing part 202 informs the backup management part 221 of the content receipt and passes the content to the backup management part 221. Thereafter, the process proceeds to operation S134. In operation S134, the downstream receiving analyzing part 202 may request the mobile terminal-directed transmitting part 203 to transmit the downloaded content to the mobile terminal 300a.

FIG. illustrates a flow of the upstream content analysis process performed in the backup server.

The upstream receiving analyzing part 212 of the backup server 200a analyzes data received from the mobile terminal 300a (operation S141). The upstream receiving analyzing part 212 determines whether or not the received data is a control message for the backup server 200a (operation S142).

When it is determined that the received data is a control message for the backup server 200a (Yes in operation S142), the process proceeds to operation S143, and when not (No in operation S142), the process proceeds to operation S144.

In operation S143, the upstream receiving analyzing part 212 informs the backup management part 221 of the received control message. On the other hand, in operation S144, the upstream receiving analyzing part 212 may request the network-directed transmitting part 213 to issue a download request for a desired content to the content server 100a.

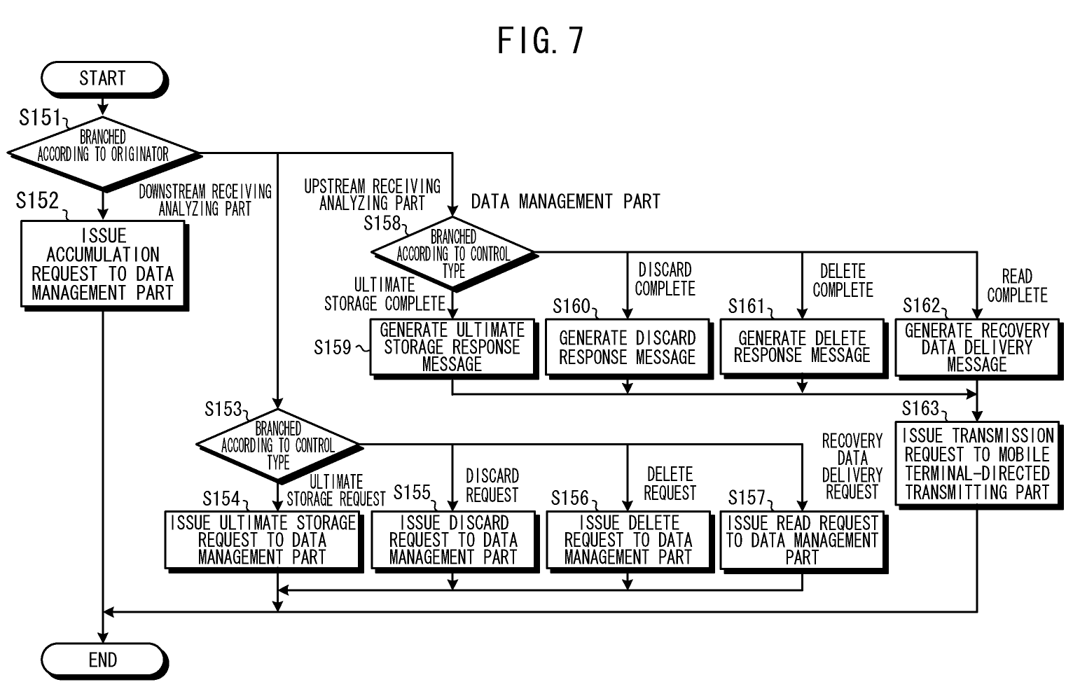

FIG. 7 illustrates a flow of the information signal receiving process performed in the backup server.

The backup management part 221 of the backup server 200a determines an originator of an information signal (operation S151). When the originator of the information signal is the downstream receiving analyzing part 202, the process proceeds to operation S152, when it is the upstream receiving analyzing part 212, the process proceeds to operation S153, and when it is the data management part 222, the process proceeds to operation S158.

In operation S152, the backup management part 221 may request the data management part 222 to temporarily accumulate a downloaded content in the temporary accumulation memory part 231.

In operation S153, the backup management part 221 determines the control type of the information signal (i.e., the type of a control message). When the control type of the information signal is an ultimate storage request, the process proceeds to operation S154, when it is a discard request, the process proceeds to operation S155, when it is a delete request, the process proceeds to operation S156, and when it is a recovery data delivery request, the process proceeds to operation S157.

In operation S154, the backup management part 221 issues a request, to the data management part 222, for ultimately storing, in the storage part 232, a corresponding content having been temporarily accumulated in the temporary accumulation memory part 231.

In operation S155, the backup management part 221 may request the data management part 222 to discard a corresponding content having been temporarily accumulated in the temporary accumulation memory part 231. In operation S156, the backup management part 221 issues a request, to the data management part 222, for deleting a corresponding content having been ultimately stored in the storage part 232. In operation S157, the backup management part 221 issues a request, to the data management part 222, for reading a corresponding content having been ultimately stored in the storage part 232.

In operation S158, the backup management part 221 determines the control type of the information signal. When the control type of the information signal is ultimate storage complete, the process proceeds to operation S159, when it is discard complete, the process proceeds to operation S160, when it is delete complete, the process proceeds to operation S161, and when it is recovery data read complete, the process proceeds to operation S162.

In operation S159, the backup management part 221 generates an ultimate storage response message to be transmitted to the mobile terminal 300a. In operation S160, the backup management part 221 generates a discard response message to be transmitted to the mobile terminal 300a. In operation S161, the backup management part 221 generates a delete response message to be transmitted to the mobile terminal 300a. In operation S162, the backup management part 221 generates a recovery data delivery response message to be transmitted to the mobile terminal 300a.

After executing operation S159, operation S160, operation S161 or operation S162, the backup management part 221 issues a request, to the mobile terminal-directed transmitting part 203, for transmitting the message generated in operation S159, operation S160, operation S161 or operation S162 to the mobile terminal 300a.

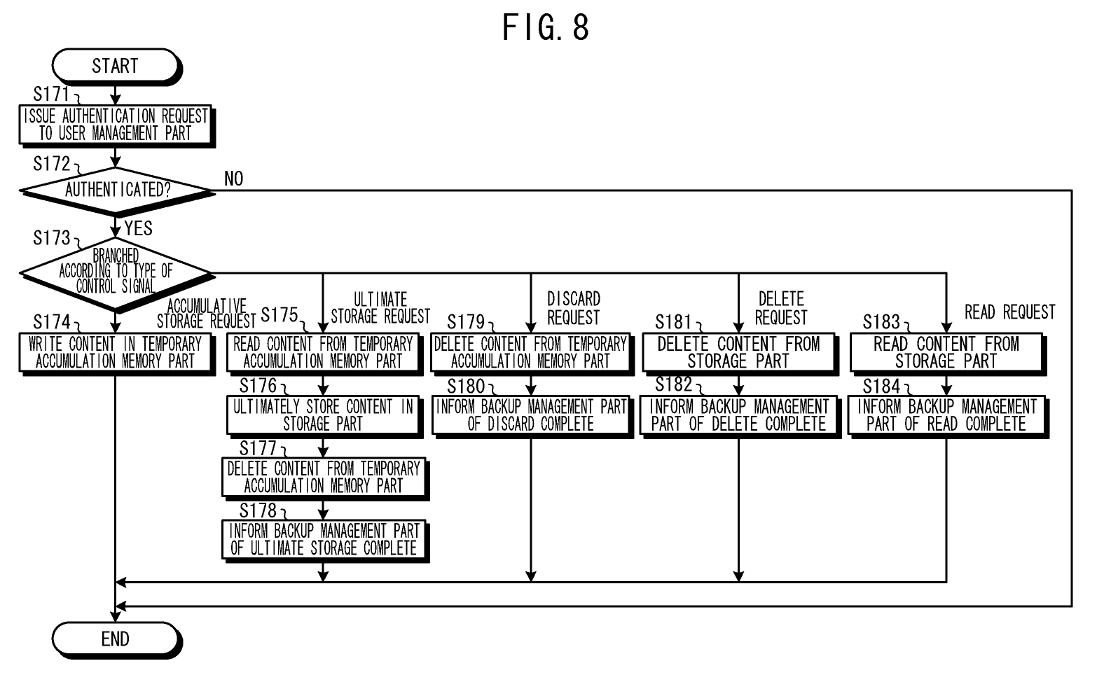

FIG. 8 illustrates a backup process performed in the backup server.

The data management part 222 may request the user management part 223 to perform authentication of a user based on a user identifier of the mobile terminal 300a, that is, the originator of a control message (operation S171). The user authentication process will be described in detail later.

The data management part 222 determines whether or not the user has been successfully authenticated by the user management part 223 (operation S172). When it is determined that the user has been successfully authenticated by the user management part 223 (Yes in operation S172), the process proceeds to operation S173, and when not (No in operation S172), the backup process is completed.

In operation S173, the data management part 222 determines the type of the control signal supplied from the backup management part 221. When the type of the control message is determined to be an accumulative storage request, the process proceeds to operation S174, when it is determined to be an ultimate storage request, the process proceeds to operation S175, when it is determined to be a discard request, the process proceeds to operation S179, when it is determined to be a delete request, the process proceeds to operation S181, and when it is determined to be a read request, the process proceeds to operation S183.

In operation S174, the data management part 222 writes a content downloaded from the content server 100a in the temporary accumulation memory part 231.

In operation S175, the data management part 222 reads a content from the temporary accumulation memory part 231. The data management part 222 ultimately may store the content read in operation S175 in the storage part 232 (operation S176). Then, the data management part 222 deletes the content from the temporary accumulation memory part 231 (operation S177). Thereafter, the data management part 222 informs the backup management part 221 of ultimate storage complete (operation S178).

In operation S179, the data management part 222 deletes a specified content from the temporary accumulation memory part 231. The data management part 222 informs the backup management part 221 of discard complete (operation S180).

In operation S181, the data management part 222 deletes a specified content from the storage part 232. The data management part 222 informs the backup management part 222 of delete complete (operation S182).

In operation S183, the data management part 222 reads a specified content from the storage part 232. The data management part 222 informs the backup management part 221 of read complete (operation S184).

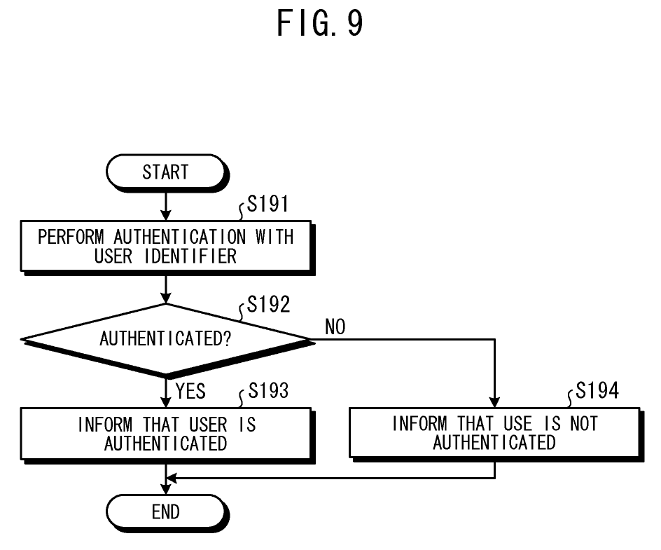

N FIG. 9 illustrates a flow of the user authentication process performed in the backup server.

The user management part 223 of the backup server 200a performs authentication by using a user identifier (operation S191). The user management part 223 determines whether or not the user has been successfully authenticated (operation S192). When the user is determined to have been authenticated (Yes in operation S192), the user management part 223 informs the data management part 222 that “the user has been authenticated” (operation S193), and when not (No in operation S192), the user management part 223 informs the data management part 222 that “the user has not been authenticated” (operation S194).

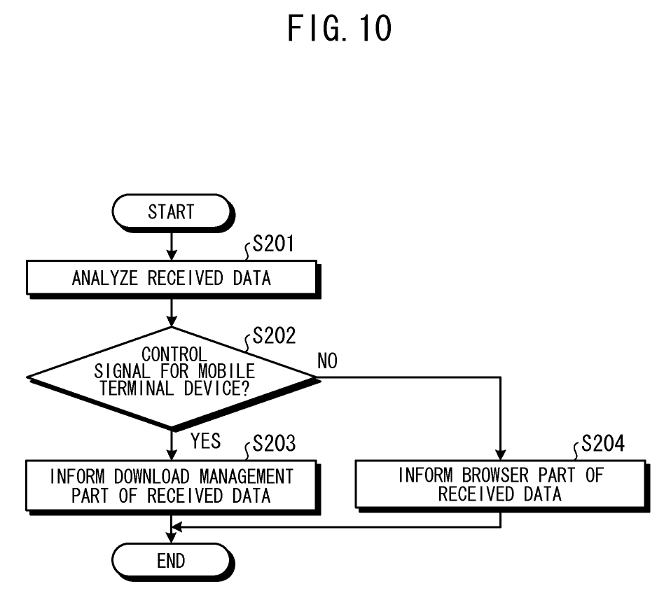

FIG. 10 illustrates an exemplary a flow of the control signal receiving process performed in a mobile terminal in a first exemplary embodiment.

The receiving analyzing part 302 of the mobile terminal 300a analyzes received data (operation S201). Then, the receiving analyzing part 302 determines whether or not the received data is a control signal for the mobile terminal 300a (operation S202).

When it is determined that the received data is a control signal for the mobile terminal 300a (Yes in operation S202), the download management part 321 is informed of the control signal (operation S203), and when not (No in operation S202), the browser part 323 is informed of the received data (operation S204).

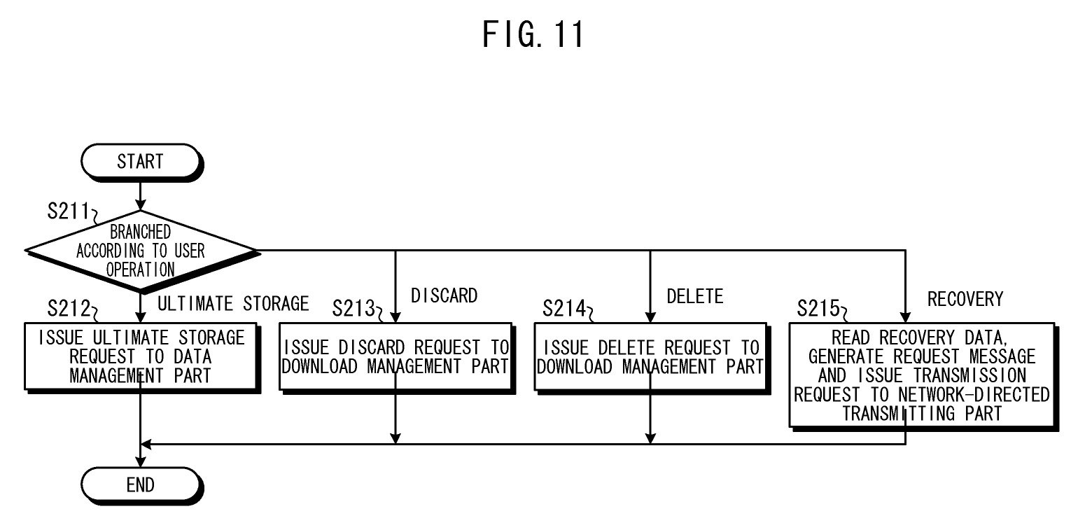

FIG. 11 illustrates a flow of the user operation accepting process performed in the mobile terminal.

The download management part 321 of the mobile terminal 300a determines the type of a user operation accepted by the user second operation part 325 (operation S211). When the type of the user operation is determined to be ultimate storage of a content, the process proceeds to operation S212, when it is determined to be discard of a content, the process proceeds to operation S213, when it is determined to be delete of a content, the process proceeds to operation S214, and when it is determined to be recovery of a content, the process proceeds to operation S215.

In operation S212, the download management part 321 issues an ultimate storage request, to the data management part 322, for reading a content having been temporarily accumulated in the temporary accumulation memory part 331 to move it to the nonvolatile memory part 332.

In operation S213, the download management part 321 issues a request, to the data management part 322, for discarding a content having been temporarily accumulated in the temporary accumulation memory part 331.

In operation S214, the download management part 321 issues a request, to the data management part 322, for deleting a content having been ultimately stored in the nonvolatile memory part 332.

In operation S215, the download management part 321 generates a content read request to be sent to the backup server 200a for content recovery, and issues a request, to the network-directed transmitting part 303, for transmitting the content read request to the backup server 200a.

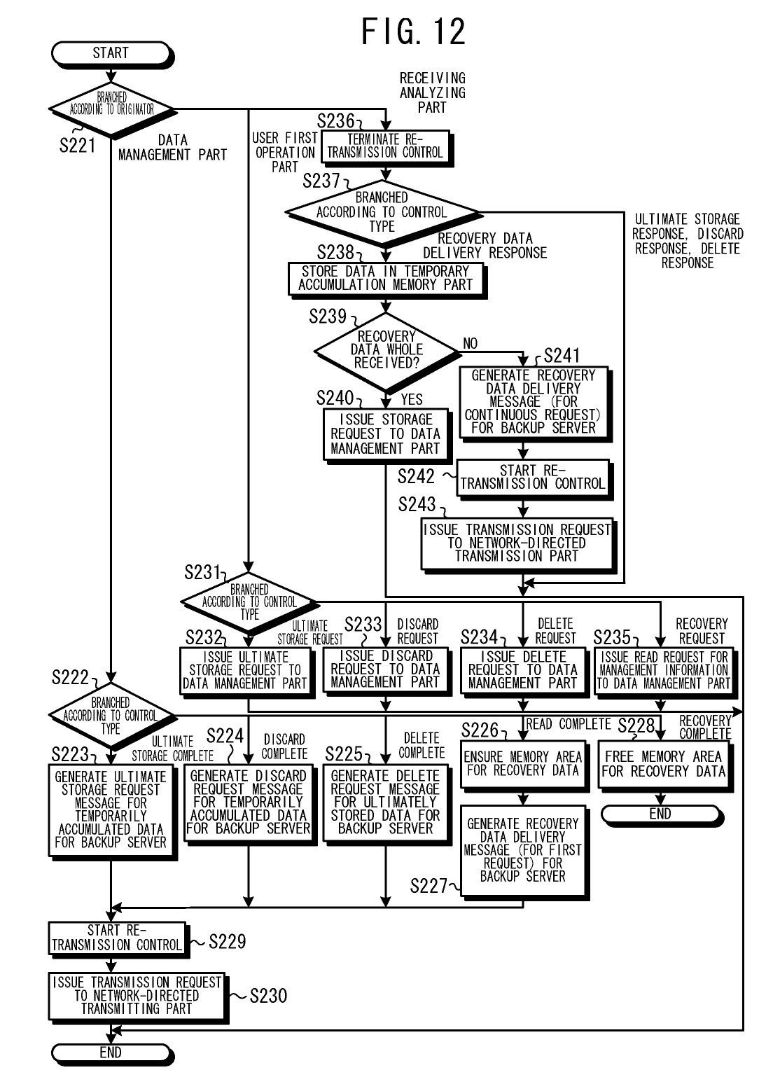

FIG. 12 illustrates a flow of the control signal receiving process performed in the mobile terminal.

The download management part 321 of the mobile terminal 300a determines the originator of a control signal (operation S221). When the originator of the control signal is determined to be the data management part 322, the process proceeds to operation S222, when it is determined to be the user first operation part 324, the process proceeds to operation S231, and when it is determined to be the receiving analyzing part 302, the process proceeds to operation S236.

In operation S222, the download management part 321 determines the type of the control message sent from the data management part 322. When the type of the control message sent from the data management part 322 is ultimate storage complete, the process proceeds to operation S223, when it is discard complete, the process proceeds to operation S224, when it is delete complete, the process proceeds to operation S225, when it is read complete, the process proceeds to operation S226, and when it is recovery complete, the process proceeds to operation S228.

In operation S223, the download management part 321 generates an ultimate storage request message for temporarily accumulated data for the backup server 200a. Thereafter, the process proceeds to operation S229.

In operation S224, the download management part 321 generates a discard request message for temporarily accumulated data for the backup server 200a. Thereafter, the process proceeds to operation S229.

In operation S225, the download management part 321 generates a delete request message for ultimately stored data for the backup server 200a. Thereafter, the process proceeds to operation S229.

In operation S226, the download management part 321 ensures, in the temporary accumulation memory part 331, a memory area for temporarily accumulating recovery data. The download management part 321 generates a recovery data delivery message (for first request) for the backup server 200a (operation S227). Thereafter, the process proceeds to operation S229.

In operation S228, the download management part 321 frees the memory area ensured in operation S226. Thereafter, the control signal receiving process is completed.

In operation S229, the download management part 321 starts retransmission control. The download management part 321 issues a transmission request, to the network-directed transmitting part 303, for transmitting the control message generated in operation S223, operation S224, operation S225 or operation S227 to the backup server 200a (operation S230).

In operation S231, the download management part 321 determines the control type of a user operation accepted by the user first operation part 324. When the control type of the user operation is determined to be an ultimate storage request, the process proceeds to operation S232, when it is determined to be a discard request, the process proceeds to operation S233, when it is determined to be a delete request, the process proceeds to operation S234, and when it is determined to be a recovery request, the process proceeds to operation S235.

In operation S232, the download management part 321 issues a request, to the data management part 222, for ultimately storing, in the storage part 232, a content requested for the ultimate storage. Thereafter, the control signal receiving process is completed.

In operation S233, the download management part 321 issues a request, to the data management part 222, for discarding, from the temporary accumulation memory part 231, a content requested for the discard. Thereafter, the control signal receiving process is completed.

In operation S234, the download management part 321 issues a request, to the data management part 222, for deleting, from the storage part 232, a content requested for the delete. Thereafter, the control signal receiving process is completed.

In operation S235, the download management part 321 issues a request, to the data management part 222, for reading management information of a content requested for the recovery from the storage part 232. Thereafter, the control signal receiving process is completed.

In operation S236, the download management part 321 terminates the retransmission control started in operation S229 or operation S242 described later. The download management part 321 determines the control type passed from the receiving analyzing part 302 (operation S237).

When the control type is a recovery data delivery response, the process proceeds to operation S238, and when it is an ultimate storage response, a discard response or a delete response, the control signal receiving process is completed.

In operation S238, the download management part 321 issues a request, to the data management part 222, for accumulating the received recovery data in the temporary accumulation memory part 231. The download management part 321 determines whether or not whole the recovery data has been received (operation S239).

When it is determined that the whole recovery data has been received (Yes in operation S239), the process proceeds to operation S240, and when not (No in operation S239), the process proceeds to operation S241.

In operation S241, the download management part 321 generates a recovery data delivery message (for continuous request) for the backup server 200a. The download management part 321 starts the retransmission control (operation S242). Then, the download management part 321 issues a request, to the network-directed transmitting part 303, for transmitting the recovery data delivery message (for continuous request) generated in operation S241 (operation S243). Thereafter, the control signal receiving process is completed.

When a content is downloaded to the mobile terminal 300a from the content server, the user operation of the mobile terminal 300a and the backup process for the content performed in the backup server 200a are performed synchronously with each other, and therefore, the content can be mirrored in the backup server 200a on a real-time basis without uploading the content ultimately stored in the mobile terminal 300a to the backup server 200a. Accordingly, even when there arises a problem in data of the content and the content cannot be reproduced, a user of the mobile terminal 300a can easily recover the data.

Furthermore, also when a content ultimately stored in the mobile terminal 300a is deleted, a user operation performed in the mobile terminal 300a and the delete process for the content performed in the backup server 200a are carried out synchronously with each other, and therefore, resources of the storage part 232 of the backup sever 200a can be efficiently used without leaving unnecessary backup contents in the backup server 200a. Accordingly, in this system, the user of the mobile terminal can attain synchronization of contents in the mobile terminal 300a and in the backup server 200a without intentionally performing a backup operation.

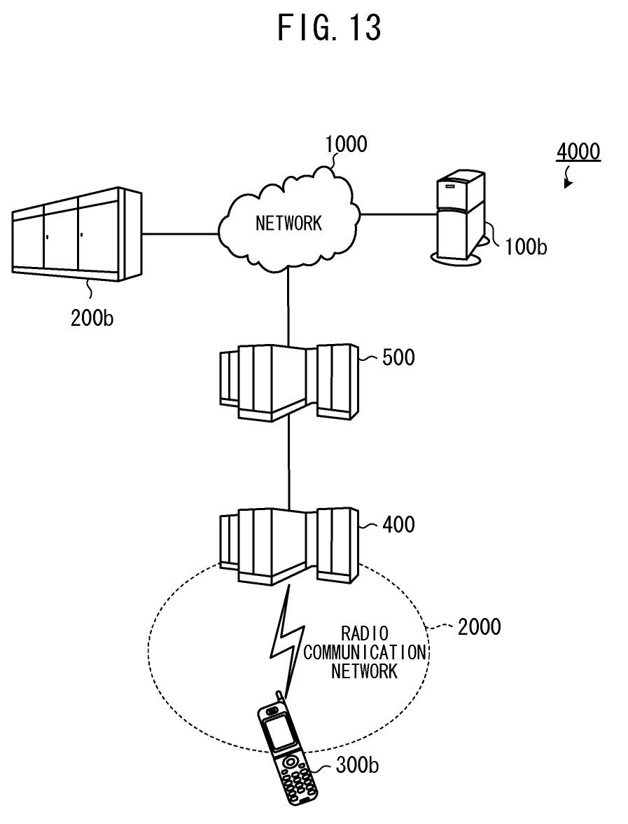

FIG. 13 illustrates a content delivery system in a second exemplary embodiment. As illustrated in FIG. 13, the content delivery system 4000 includes a contents server 100b, a backup server 200b and a gateway server 500 connected to a network 1000.

The gateway server 500 may transmit, directly to the content server 100b, a content delivery request packet sent from a mobile terminal 300b to the content server 100b through a base station server 400.

When the content server 100b receives a content delivery request from the gateway server 500, the content server 100b may transmit a corresponding content to the mobile terminal 300b, that is, the originator of the content delivery request, and also to the backup server 200b. The backup server 200b temporarily may store the content received from the content server 100b.

The mobile terminal 300b temporarily may store the received content. Then, the mobile terminal 300b ultimately may store, in a nonvolatile memory or the like, the content having been temporarily stored, and instructs the backup server 200b to ultimately store, in a nonvolatile memory or the like, the content having been temporarily stored in the backup server 200b.

The backup server 200b ultimately may store the temporarily stored content in a nonvolatile memory or the like in accordance with the instruction from the mobile terminal 300b. This process corresponds to a content backup process attendant on content download.

Since the content server 100b thus may transmit a content to the mobile terminal 300b as well as to the backup server 200b, the content can be definitely backed up even when a user of the mobile terminal 300b is unaware of the backup.

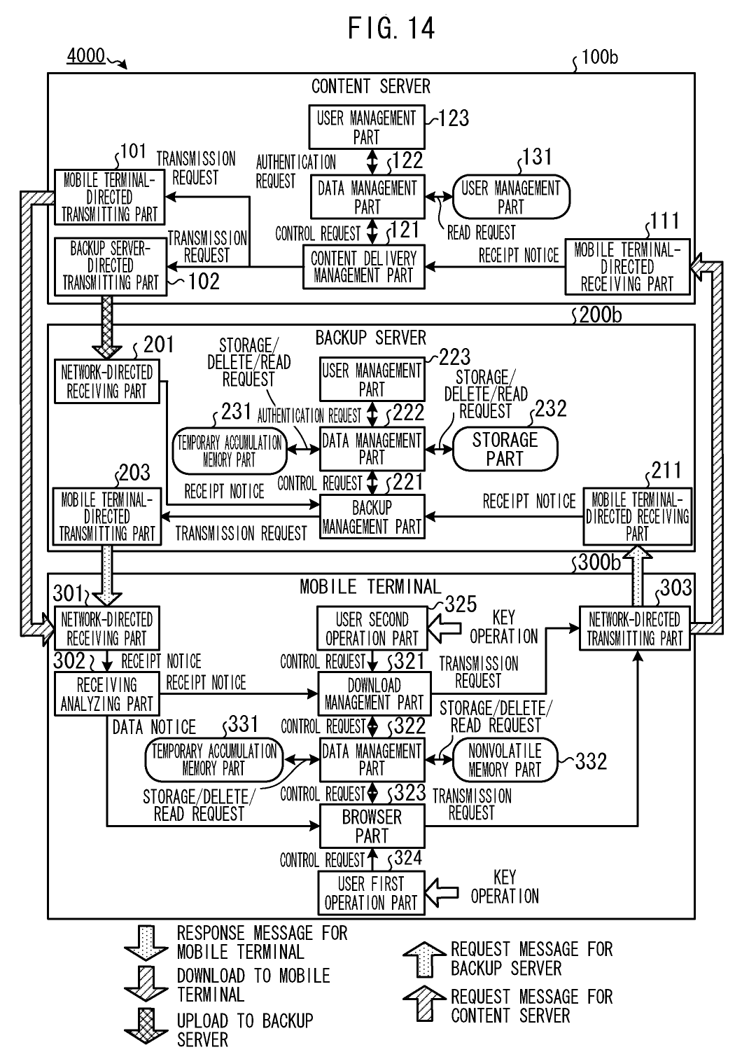

FIG. 14 illustrates a content delivery system in a second exemplary embodiment.

The content server 100b included in the content delivery system 4000 includes a mobile terminal-directed transmitting part 101, a backup server-directed transmitting part 102, a mobile terminal-directed receiving part 111, a content delivery management part 121, a data management part 122, a user management part 123 and a content data storage part 131.

Furthermore, the backup server 200b included in the content delivery system 4000 has an architecture similar to that of the backup server 200a except that the downstream receiving analyzing part 202 and the upstream receiving analyzing part 212 are omitted, and the processes may be different.

Moreover, the mobile terminal 300b included in the content delivery system 4000 has an architecture similar to that of the mobile terminal 300a, and the processes may be may be different.

A content delivery (download) request process is described with respect to a difference from those of the content delivery system 3000. A content delivery request issued by the mobile terminal 300b is directly transmitted to the content server 100b.

The content server 100b receives the content delivery request message from the mobile terminal 300b by the mobile terminal-directed receiving part 111. Then, the content delivery management part 121 is informed of the received content delivery request message.

The content delivery management part 121 may transmit, to the data management part 122, a content data read request together with a user identifier of the mobile terminal 300b. The data management part 122 may request the user management part 123 to perform user authentication by using the user identifier of the mobile terminal 300b. When the user has been successfully authenticated, a desired content stored in the content data storage part 131 is read to be transmitted to the content delivery management part 121. The content delivery management part 121 may transmit the content received from the data management part 122 to the mobile terminal-directed transmitting part 101. When the content is data that can be backed up, the content is transmitted also to the backup server-directed transmitting part 102.

The content is transmitted from the content server 100b directly to the mobile terminal 300b as well as directly to the backup server 200b.

Ultimate storage of a content in the backup server 200b and the mobile terminal 300b is described with respect to a difference from those of the content delivery system 3000.

In ultimate storage of a content, when the backup server 200b receives an ultimate storage request message for a content from the mobile terminal 300b by the mobile terminal-directed receiving part 211, the backup management part 221 is informed of the receipt.

The backup management part 221 analyzes the message informed by the mobile terminal-directed receiving part 211, and when it is determined to be an ultimate storage request from the mobile terminal 300b, the backup management part 221 issues an ultimate storage request to the data management part 222 with a user identifier of the mobile terminal 300b, a hash value based on corresponding content data and a storage file name specified.

A discard of a content having been temporarily accumulated in the backup server 200b and the mobile terminal 300b are described with respect to a difference from those of the content delivery system 3000.

The backup server 200b receives a discard request message from the mobile terminal 300b by the mobile terminal-directed receiving part 211, and the backup management part 221 is informed of the receipt.

The backup management part 221 analyzes the message informed by the mobile terminal-directed receiving part 211, and when it is determined to be a discard request from the mobile terminal 300b, the backup management part 221 issues a discard request to the data management part 222 with a user identifier of the mobile terminal 300b and a temporary accumulation file name specified.

Deletion of a content having been ultimately stored in the backup server 200b and the mobile terminal 300b are described with respect to a difference from those of the content delivery system 3000.

The backup server 200b receives a delete request message from the mobile terminal 300b by the mobile terminal-directed receiving part 211, and the backup management part 221 is informed of the receipt.

The backup management part 221 analyzes the massage informed by the mobile terminal-directed receiving part 211, and when it is determined to be a delete request from the mobile terminal 300b, the backup management part 221 issues a delete request to the data management part 222 with a user identifier of the mobile terminal 300b and a storage file name specified.

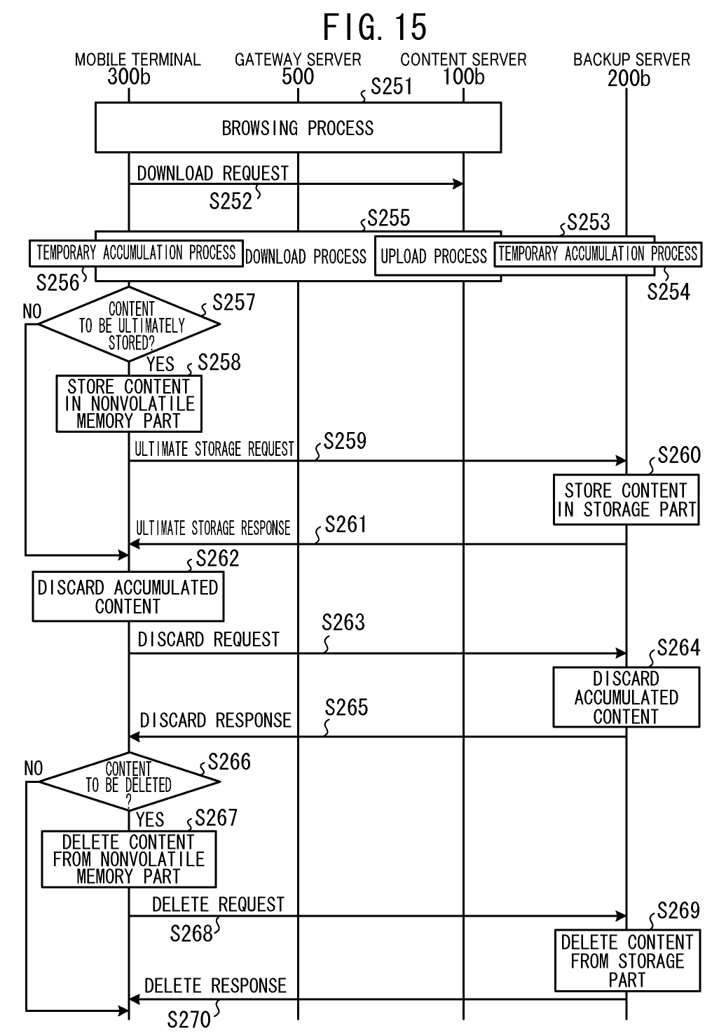

Now, a content backup process performed in the content delivery system exemplified in Embodiment 2 will be described. FIG. 15 is a sequence diagram illustrating the content backup process performed in the content delivery system exemplified in Embodiment 2.

The mobile terminal 300b makes the content server 100b perform a browsing process for a desired content (operation S251). The mobile terminal 300b may request the content server 100b to download a specified content (operation S252). In response to this request, the content server 100b uploads the content to the backup server 200b (operation S253).

The backup server 200b performs a temporary accumulation process for temporarily accumulating the content uploaded from the content server 100b in the temporary accumulation memory part 231 (operation S254).

The content server 100b performs a download process for transmitting, to the mobile terminal 300b, the same content as that transmitted to the backup server 200b in operation S253 (operation S255). Then, the mobile terminal 300b performs a temporary accumulation process for temporarily accumulating the content downloaded from the content server 100b in the temporary accumulation memory part 331 (operation S256).

Thereafter, the mobile terminal 300b determines, based on a user operation, whether or not the content temporarily accumulated in operation S254 is to be ultimately stored in the nonvolatile memory part 332 (operation S257). When it is determined to be ultimately stored in the nonvolatile memory part 332 (Yes in operation S257), the process proceeds to operation S258, and when not (No in operation S257), the process proceeds to operation S262.

In operation S258, the mobile terminal 300b ultimately may store the content in the nonvolatile memory part 332. Then, the mobile terminal 300b may transmit, to the backup sever 200b, an ultimate storage request message for ultimately storing the content in the storage part 232 (operation S259).

The backup server 200b having received the ultimate storage request message from the mobile terminal 300b ultimately may store the content in the storage part 232 (operation S260). Then, the backup server 200b may transmit an ultimate storage response message to the mobile terminal 300b (operation S261).

The mobile terminal 300b discards the content temporarily accumulated in operation S254 (operation S262). Then, the mobile terminal 300b may transmit, to the backup server 200b, a discard request message for discarding the content from the temporary accumulation memory part 231 (operation S263).

The backup server 200b having received the discard request message from the mobile terminal 300b discards the content from the temporary accumulation memory part 231 (operation S264). Then, the backup server 200b may transmit a discard response message to the mobile terminal 300b (operation S265).

Thereafter, the mobile terminal 300b determines, based on a user operation, whether or not the content ultimately stored in operation S258 is to be deleted from the nonvolatile memory part 332 (operation S266). When it is determined to be deleted from the nonvolatile memory part 332 (Yes in operation S266), the process proceeds to operation S267, and when not (No in operation S266), the content backup process is completed.

In operation S267, the mobile terminal 300b deletes the content from the nonvolatile memory part 332. Then, the mobile terminal 300b may transmit, to the backup server 200b, a delete request message for deleting the content from the storage part 232 (operation S268).

The backup server 200b having received the delete request message from the mobile terminal 300b deletes the content from the storage part 232 (operation S269). Then, the backup server 200b may transmit a delete response message to the mobile terminal 300b (operation S270).

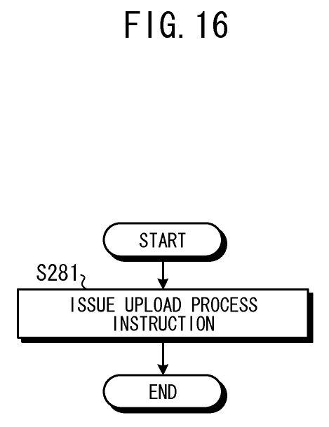

FIG. 16 is a flowchart illustrating a flow of the upload process performed in a content server. Before instructing the mobile terminal-directed transmitting part 101 to transmit a corresponding content to the mobile terminal 300b in response to a content delivery request from the mobile terminal 300b, the content delivery management part 121 of the content server 100b instructs the backup server-directed transmitting part 102 to perform an upload process for the backup of the content to the backup server 200b (operation S281).

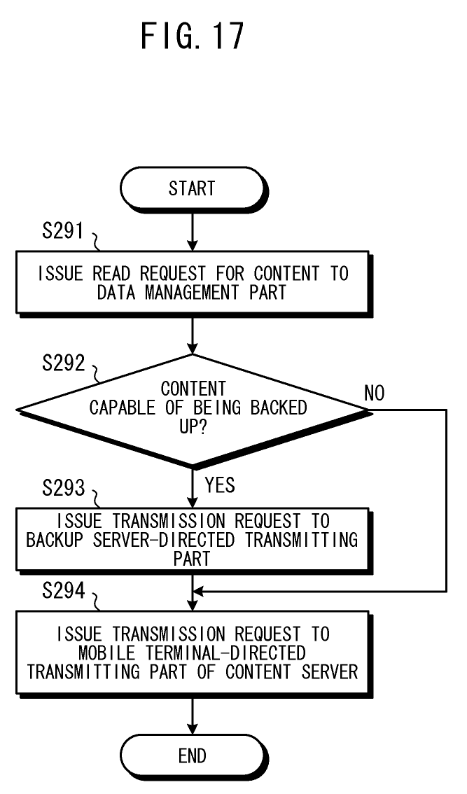

FIG. 17 illustrates a flow of the content delivery process performed in a content server.

The content delivery management part 121 issues, to the data management part 122, a request for reading a content requested for delivery from the content data storage part 131 (operation S291). Then, the content delivery management part 121 determines whether or not the content is a content capable of being backed up (operation S292). At this point, a content capable of being backed up is, for example, a content allowed to be backed up in the content delivery system 4000.

When the content is determined to be a content capable of being backed up (Yes in operation S292), the process proceeds to operation S293, and when not, the process proceeds to operation S294.

In operation S293, the content delivery management part 121 issues, to the backup server-directed transmitting part 102, a request for transmitting the content to the backup server 200b.

The content delivery management part 121 issues, to the mobile terminal-directed transmitting part 101 of the content server 100b, a request for transmitting the content to the mobile terminal 300b (operation S294).

A content downloaded from the content server 100a (or 100b) that delivers respective contents may be managed for backup in a centralized manner by the backup server 200a (or 200b) prepared by a communications business company so as to be mirrored with a content stored in the mobile terminal 300a (or 300b).

Accordingly, even when the mobile terminal 300a (or 300b) is changed in the model or initialized for repair or the like, there is no need to re-download the content from the content server 100a (or 100b) delivering the respective contents. Instead, the data can be recovered by downloading the content from the backup server 200a (or 200b).

Furthermore, even when the provision of a content having been downloaded and backed up in the backup server 200a (or 200b) is finished on the side of a provider of the content, since the content is backed up in the backup server 200a (or 200b), the content having been downloaded to the mobile terminal 300a (or 300b) can be completely recovered.

Conventionally, it is necessary to upload a content to the backup server 200a (or 200b) in order to backup the content stored in the mobile terminal 300a (or 300b). In contrast, according to an exemplary embodiment, there is no need to upload a content and there is no need to use a network or a radio resource for the upload, and hence, the traffic on the network can be reduced, resulting in realizing a content delivery system with high energy efficiency.

In addition, even when a content is copyrighted, since it is backed up in the backup server 200a (or 200b) having the authentication mechanism for preventing the use by a third party, convenience for a user of the mobile terminal 300a (or 300b) can be improved while protecting the right of the provider of the content.

In an exemplary embodiment, the nonvolatile memory part 332 may be a storage device integrated with the mobile terminal 300a (or 300b). Therefore, when a content is moved for ultimate storage from the temporary accumulation memory part 331 to the nonvolatile memory part 332, the backup of the content in the backup server 200a (or 200b) is valid.

When the nonvolatile memory part 332 is, however, an external storage device (such as a compact nonvolatile storage medium to be inserted into the mobile terminal 300a (or 300b)), even if the mobile terminal 300a (or 300b) goes down, a content stored in the external storage device may be used with the external storage device loaded on another mobile terminal.

Accordingly, all the contents downloaded from the content server 100a (or 100b) to the mobile terminal 300a (or 300b) are not backed up in the backup server 200a (or 200b) but a content downloaded when the nonvolatile memory part 332 is an external storage device may not be backed up in the backup server 200a (or 200b).

In other words, a content to be backed up in the backup server 200a (or 200b) may be selected through instruction given by a user or in consideration of various conditions such as the type of content and whether or not the nonvolatile memory part 332 is an external storage device. Thus, the memory resource of the storage part 232 of the backup server 200a (or 200b) can be efficiently used.

In an exemplary embodiment in the backup of a content in the backup server 200a (or 200b), contents are backed up with respect to every user identifier of the mobile terminal 300a (or 300b).

Instead, every content may be backed up in correspondence to a user identifier of a user that carries out the backup. In this case, the memory resource of the storage part 232 of the backup server 200a (or 200b) can be efficiently used.

Exemplary processes may be automatically performed or manually performed. In addition, specific terms mentioned in the exemplified embodiments about the process procedures, the control procedures, specific appellatives, various data and parameters can be arbitrarily modified unless otherwise mentioned.

Forms of dispersion and integration of the respective devices are not limited to those illustrated and devices may be functionally or physically dispersed or integrated based on various loads or use conditions.

Furthermore, a or part of a process of each device may be realized by a CPU (Central Processing Unit) (or a micro computer such as an MPU (Micro Processing Unit) or an MCU (Micro Controller Unit)), and program analyzed and executed by the CPU (or the micro computer such as the MPU or the MCU) or may be realized by hardware through a wired logic.

According to an exemplary delivery data backup apparatus, the delivery data backup method and the delivery data backup program, delivery data may be stored for backup automatically in a delivery data backup apparatus in downloading the delivery data even when a user of a terminal device does not perform an operation for storing the delivery data in a delivery data backup storage device for backup. Therefore, the delivery data can be definitely and efficiently backed up even when the user of the mobile terminal is unaware of the backup of the delivery data.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-2000 (Recordable)/RW. An example of communication media includes a carrier-wave signal.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A delivery data backup apparatus comprising:
a delivery data receiving part receiving, from a data delivery server, delivery data transmitted from the data delivery server to a terminal device in response to a download request for the delivery data issued by the terminal device;
a temporary storage part temporarily storing the delivery data received by the delivery data receiving part;
a delivery data backup storage part storing, for backup, the received delivery data; and
a backup process part moving the delivery data having been temporarily stored in the temporary storage part from the temporary storage part to the delivery data backup storage part in accordance with a backup instruction for the delivery data issued by the terminal device.

2. The delivery data backup apparatus according to claim 1, further comprising:
a download request transferring part receiving the download request for the delivery data issued by the terminal device to the data delivery server and transferring the download request to the data delivery server; and
a delivery data transferring part transferring the delivery data received by the delivery data receiving part to the terminal device having issued the download request for the delivery data,
wherein the delivery data receiving part receives the delivery data transmitted from the data delivery server in response to the download request for the delivery data transferred by the download request transferring part.

3. The delivery data backup apparatus according to claim 1,
wherein the download request transferring part transfers the download request for the delivery data to the data delivery server and transfers, to the backup process part, a download request notice corresponding to the download request for the delivery data.

4. The delivery data backup apparatus according to claim 1,
wherein the delivery data receiving part receives, from the terminal device, not only the download request for the delivery data transmitted to the data delivery server but also a download request notice corresponding to the download request for the delivery data for sending the download request notice to the backup process part.

5. The delivery data backup apparatus according to claim 4,
wherein the delivery data receiving part receives the delivery data transmitted for upload from the data delivery server separately from the delivery data transmitted from the data delivery server to the terminal device in response to the download request for the delivery data issued by the terminal device.

6. The delivery data backup apparatus according to any of claims 1 to 5,
wherein the backup process part deletes the delivery data having been temporarily stored in the temporary storage part from the temporary storage part in accordance with a discard instruction for the delivery data issued by the terminal device, and deletes the delivery data having been stored in the delivery data backup storage part from the delivery data backup storage part in accordance with a delete instruction for the delivery data issued by the terminal device.

7. A data delivery apparatus that may transmit delivery data to a terminal device in response to a download request for the delivery data issued by the terminal device, the data delivery apparatus comprising:
a delivery data transmitting part transmitting the delivery data to a delivery data backup apparatus, which may store the delivery data for backup, in response to a download request for the delivery data issued by the terminal device and transferred by the delivery data backup apparatus.

8. A delivery data backup apparatus for storing delivery data supplied by a data delivery apparatus for backup, the delivery data backup apparatus comprising:
a delivery data transmitting part transmitting the delivery data received from the data delivery apparatus in response to a download request for the delivery data issued by a terminal device and transmitting the delivery data to a delivery data backup storage part for storing the delivery data for backup.

9. A delivery data backup method comprising:
receiving, from a data delivery server, delivery data transmitted from the data delivery server to a terminal device in response to a download request for the delivery data issued by the terminal device;
temporarily storing the received delivery data in a temporary storage device;
storing the delivery data for backup in an ultimate storage device; and
moving the delivery data having been temporarily stored in the temporary storage device from the temporary storage device to a delivery data backup storage device in accordance with a backup instruction for the delivery data issued by the terminal device.

10. The delivery data backup method according to claim 9, further comprising:
receiving the download request for the delivery data issued by the terminal device to the data delivery server and transferring the download request to the data delivery server; and
transferring the received delivery data to the terminal device that has issued the download request for the delivery data,
wherein the received delivery data is the delivery data transmitted from the data delivery server in response to the transferred download request for the delivery data.

11. The delivery data backup method according to claim 10,
wherein when the download request for the delivery data is transferred to the data delivery server, a download request notice corresponding to the download request for the delivery data is transferred to the backup processing operation.

12. The delivery data backup method according to claim 9,
wherein when the download request for the delivery data to be transmitted to the data delivery server is received from the terminal device, a download request notice corresponding to the download request for the delivery data is received.

13. The delivery data backup method according to claim 10,
wherein the delivery data transmitted for upload from the data delivery server is received separately from the delivery data transmitted from the data delivery server to the terminal device in response to the download request for the delivery data issued by the terminal device.

14. The delivery data backup method according to any of claims 9 to 13,
wherein the delivery data having been temporarily stored in the temporary storage device is deleted from the temporary storage device in accordance with a discard instruction for the delivery data issued by the terminal device, and
the delivery data having been stored in the delivery data backup storage device is deleted from the delivery data backup storage device in accordance with a delete instruction for the delivery data issued by the terminal device.

15. A computer-readable storage medium storing a delivery data backup program, the delivery data backup program that causes the computer to execute:
receiving, from a data delivery server, delivery data transmitted from the data delivery server to a terminal device in response to a download request for the delivery data issued by the terminal device;
temporarily storing, in a temporary storage device, the delivery data received;
storing the delivery data for backup in an ultimate storage device; and
moving the delivery data having been temporarily stored in the temporary storage device by the temporarily storing from the temporary storage device to a delivery data backup storage device in accordance with a backup instruction for the delivery data issued by the terminal device.

16. The computer-readable storage medium according to claim 15, further causing the computer as:
receiving the download request for the delivery data issued by the terminal device to the data delivery server and transferring the download request to the data delivery server; and
transferring the delivery data received by the receiving to the terminal device having issued the download request for the delivery data,
wherein the received delivery data is the delivery data transmitted from the data delivery server in response to the transferred download request for the delivery data.

17. The computer-readable storage medium according to claim 16,
wherein when the download request for the delivery data is transferred to the data delivery server, a download request notice corresponding to the download request for the delivery data is issued.

18. The computer-readable storage medium according to claim 15,
wherein when the download request for the delivery data transmitted to the data delivery server is received from the terminal device, a download request notice corresponding to the download request for the delivery data is received.

19. The computer-readable storage medium according to claim 16,
wherein the delivery data transmitted for upload from the data delivery server is received separately from the delivery data transmitted from the data delivery server to the terminal device in response to the download request for the delivery data issued by the terminal device.

20. The computer-readable storage medium according to claim 16,
wherein the delivery data having been temporarily stored in the temporary storage device is deleted from the temporary storage device in accordance with a discard instruction for the delivery data issued by the terminal device, and
the delivery data having been stored in the delivery data backup storage device is deleted from the delivery data backup storage device in accordance with a delete instruction for the delivery data issued by the terminal device.
